(19) United States
(12) Patent Application Publication
(10) Pub. No.: US 2006/0198029 A1
(43) Pub. Date: Sep. 7, 2006

(54) Microlithography projection objective and projection exposure apparatus

(76) Inventor: Karl-Heinz Schuster, Koenigsbronn (DE)

Correspondence Address: FISH & RICHARDSON PC, P.O. BOX 1022, MINNEAPOLIS, MN, 55440-1022, US

(21) Appl. No.: 11/364,015

(22) Filed: Feb. 27, 2006

Related U.S. Application Data
(60) Provisional application No. 60/658,417, filed on Mar. 2, 2005.

(30) Foreign Application Priority Data
Mar. 1, 2005 (DE) 102005009912.2

(51) Int. Cl. G02B 3/00

(52) U.S. Cl. 359/649

(57) ABSTRACT

The invention concerns a microlithography projection objective and a microlithographic projection exposure apparatus with a microlithography projection objective, having at least one lens of birefringent material. In accordance with an aspect of the invention, a microlithography projection objective has an optical axis and at least one lens of uniaxial birefringent crystal whose principal axis is oriented parallel to the optical axis, wherein all lenses of uniaxial birefringent crystal comprise the same crystal material, wherein light is tangentially polarised in the lens of uniaxial birefringent crystal and wherein the lens of uniaxial birefringent crystal has a diffractive power different from zero and has a plane exit face or a non-plane but refractive power-less exit face.

### CROSS-REFERENCE TO RELATED APPLICATION

This application claims priority of German Patent Application No. 10 2005 009912.2, filed Mar. 1, 2005, as well as U.S. Provisional Application 60/658,417, filed Mar. 2, 2005.

### BACKGROUND OF THE INVENTION

1. Field of the Invention

The invention concerns a microlithography projection objective and a microlithographic projection exposure apparatus with a microlithography projection objective, having at least one lens of birefringent material.

2. Description of the Related Art

In present microlithography objectives with working wavelengths below 365 nm, in particular 248 nm, 193 nm or 157 nm, and further in particular for immersion or near field lithography with values in respect of the numerical aperture (NA) of more than 1.0, for example 1.3 to about 2, there is increasingly a need for the use of materials with a high refractive index. Here a refractive index is referred to as being ‘high’ if its value at the specified wavelength exceeds that of quartz, at a value of about 1.56 at a wavelength of 193 nm. By way of example, for immersion or near field lithography with image-side numerical aperture above about 1.3 to about 2, at least for use in the region of the lenses which are last at the image side or close to the image side, there is a need for lens materials with a refractive index significantly greater than the value of the numerical aperture. In addition as is known lens materials with a high refractive index are also advantageous for the construction of objectives for Petzval correction which is important in respect of projection objectives for image field flattening.

E G Tsitzishvili (Sov. Phys. Semicond. 15 (10), October 1981, pages 1152-1154) reported on the optical anisotropy of cubic crystals, induced by spatial dispersion. That physical effect has in the meantime become generally known as intrinsic birefringence (‘IBR’) and compensation options have been used for cubic crystals with slight but disturbing IBR. It is e.g. known to arrange optical elements comprising crystals involving different crystal orientations relative to each other in such a way that there can be a considerable reduction in the detrimental influences of IBR on imaging. One problem in regard to the above-indicated use of highly refractive cubic crystal materials as lens elements is that highly refractive cubic crystals also have a high IBR in the DUV and VUV wavelength range.

As a depolarising action emanates from the above-indicated effect of IBR, a problem is therefore involved in transporting unaltered as far as the resist a tangential polarisation state which is produced within the illumination system or the projection objective. For high-contrast image production in the resist the aim is in particular a tangential polarisation distribution, in respect of which the oscillation planes of the E-field vectors of the individual linearly polarised rays in a pupil plane of the system are oriented in perpendicular relationship with the radius which is directed on to the optical axis. Corresponding arrangements for the production of a tangential polarisation distribution are known for example from US 2001/0019404 A1 (EP 1 130 470 A2), wherein an element influencing polarisation and which can be made up for example of segmented birefringent plates can be arranged approximately in a pupil plane.

WO 2005/059645 A2 to the inventor of the present application refers to various publications as background. In addition disclosed therein is in particular compensation for the birefringence-induced retardation by the use of different optically uniaxial crystal materials. That application is made in the full extent thereof subject-matter of the present disclosure by incorporation by reference.

Maintaining a polarisation state and transformation of an optical wavefront which is as defect-free as possible are central tasks of a lens in a lithography objective. That also applies to the example of a lens in the form of a planoconvex lens as a typical, last optical component of a lithography objective, closely in front of the substrate to be exposed (wafer). Known and discussed cubic, highly refractive crystals at that position have high intrinsic birefringence. In addition, it is necessary to reckon on considerable crystal dislocations by virtue of the multiply oxidic crystal nature and crystal growth or production process. Crystal dislocations have an effect directly on both polarisation-optical wavefronts which are separated in the crystal. That means that a beam which should originally have afforded a tangentially polarised image production, caused by crystal dislocations, provides an elliptical polarised partial beam for interferential image production and the level of image contrast falls, in further intensification it provides the contrast zero or even causes a phase jump and in the image leads to apparent resolution.

### SUMMARY OF THE INVENTION

With the foregoing background in mind an object of the present invention is to provide a microlithography projection objective which permits the use of relatively highly refractive crystal materials without an unwanted influence on the polarisation state.

That object is attained by the features of the independent claims.

Preferred configurations are set forth in the description and the appendant claims.

In accordance with an aspect a microlithography projection objective has an optical axis and at least one lens of uniaxial birefringent crystal whose principal axis is oriented parallel to the optical axis, wherein all lenses of uniaxial birefringent crystal comprise the same crystal material, wherein light is tangentially polarised in the lens of uniaxial birefringent crystal and wherein the lens of uniaxial birefringent crystal has a diffractive power different from zero and has a plane exit face or a non-plane but refractive power-less exit face.

The invention follows the concept of allowing materials involving relatively great birefringence and, instead of compensation in that respect, permitting undisturbed imaging by way of the co-operation between a defined polarisation state of the light in the lens or lenses in question, a specific beam geometry and crystal geometry. It was surprisingly found that there is a physical possibility of transporting the polarisation state over relatively great distances even in real crystals with considerable crystal dislocations. That is successful if the birefringence tensor of the crystal dislocation is considerably less than a permanently impressed birefringence tensor as is provided by a non-cubic crystal system. Here the incident wave or the incident ray is definitely locally linearly polarised in relation to that birefringence tensor with its large individual contribution. Polarisation of each light ray in the material of the lens according to the invention is optimally polarised in perpendicular or parallel relationship to a plane which is defined by the directions of the ray and the birefringence tensor. That is achieved with tangential polarisation but also with radial polarisation. Linear polarisation may also suffice for limited beams—for example in the case of dipole illumination. If a ray satisfies that requirement upon first immersion into the lens (of crystal), it remains practically undisturbed in respect of polarisation state by additional anisotropies such as IBR, crystal dislocations, birefringence due to heat and mechanical stress. It will be noted however that admittedly not the polarisation state but in fact the optical path of the ray can be influenced. The optical path once again, that is to say the disturbance in the overall refraction of the lens, can be compensated (in part) by common processes such as local deformation of the optical outside surfaces of lenses and plates. Experience has shown that the IBR encountered in cubic crystals is too small to furnish a sufficiently large birefringence tensor. In addition there the IBR is not rotationally symmetrical as in the case of the uniaxial crystal but is manifold and continuously assumes other amounts in different spatial directions.

A uniaxial crystal provides a sufficiently large permanent tensor when at an exposure wavelength the magnitude of |nₑ−nₒ|>1·10⁻⁶, preferably >1·10⁻⁵ to >1·10⁻⁴. In that respect nₒ denotes the refractive index of the ordinary ray and nₑ denotes the refractive index of the extraordinary ray.

In the particular situation of high-aperture lithography with an image-side numerical aperture of significantly above 1.0 the tangential polarisation is good in order to obtain a high-contrast image structure.

In accordance with the invention the procedure involved is now as follows:

In a suitable configuration the projection objective is almost doubly telecentric and it images the object in the image in almost conformal and distortion-free fashion. The entrance aperture is illuminated over the entire object field (reticle) almost tangentially polarised (or dipole-tangentially polarised). The subsequent part of the objective is substantially free from anisotropies (for example quartz with low stress birefringence). The last element before the image field (substrate, wafer) is a planoconvex lens with following immersion or in the near field spacing relative to the image field or a positive meniscus with a subsequent immersion fluid, wherein the refractive indices of meniscus and immersion should almost coincide. In accordance with the invention that last lens then comprises an optically uniaxial crystal material.

The invention is therefore based in particular on the realisation that, in the case of a projection objective which is telecentric at the image side (in particular doubly telecentric, that is to say at the object side and at the image side), and in which the lens which is last at the image side is of optically uniaxial crystal material with a plane terminal face, the light which was tangentially polarised originally (that is to say before the lens which is last at the image side) also passes in a tangentially polarised state into the wafer and thus no further compensation is required in that respect. That is due to the fact that the tangential polarisation state of the coma rays automatically occurs again in front of the wafer plane, even if it has previously rotated due to refraction at curved lens faces. If the last lens element in front of the wafer plane has a plane terminal face or the transition from the last lens element to the immersion fluid is refractive power-less (i.e. without refractive power), the light is already tangentially polarised in the last lens element. If now the optical axis (principal axis) of the optically uniaxial crystal faces in the direction of the optical axis of the objective the polarisation state is not further influenced.

In general, in one aspect, the invention features a microlithography projection objective having an optical axis and at least one lens of uniaxial birefringent crystal whose principal axis is oriented parallel to the optical axis. All lenses of uniaxial birefringent crystal include the same crystal material, light is tangentially polarised in the lens of uniaxial birefringent crystal, and the lens of uniaxial birefringent crystal has a diffractive power different from zero and has a plane exit face or a non-plane but refractive power-less exit face.

In general, in another aspect, the invention features a microlithography projection objective having an optical axis and at least two lenses of uniaxial birefringent crystal whose principal axes are oriented parallel to the optical axis. The at least two lenses are arranged rotated relative to each other about their principal axes.

Embodiments of the microlithography projection objectives can include one or more of the following features.

The microlithography projection objective can be characterised in that it has an image field with a plurality of image elements with each of which a respective chief ray is associated, wherein each chief ray in all lenses of uniaxial birefringent crystal extends at an angle of less than 2°, preferably less than 1°, further preferably less than 0.5°, relative to the optical axis of the projection objective.

The crystal material can be selected from the group which contains sapphire, akermanite, gehlenite, beryllium, apatite, terbium fluoride, beryllium oxide, cerium fluoride, neodymium fluoride, praseodymium fluoride, lanthanum fluoride, phenakite, AlPO₄, aluminum nitride, lithium nitrate, chloromagnesite, fluoroapatite, Al₈O₁₇Sr₅, taaffeite and dolomite.

The microlithography projection objective can be telecentric at the image side.

At least one lens or at least one of the at least two lenses can count among three optical elements which are closest to the image plane.

The microlithography projection objective can be characterised in that it is used at a wavelength of light and at said wavelength the material has a difference in the refractive indices for the ordinary and extraordinary rays, which exceeds 1·10⁻⁵.

The refractive index for the ordinary ray of the material of said lens can numerically exceed an image-side numerical aperture by more than 0.15 through 1.

At least one lens or at least one of the at least two lenses can carry on its entrance face an isotropic layer whose refractive index is equal to a refractive index in the range from the ordinary to the extraordinary refractive index of the material of said lens.

The at least one lens or at least one of the at least two lenses can be a planoconcave lens. An immersion fluid can be arranged between the lens and an adjacent lens. The lens can be preceded in the ray path by a second lens whose adjacent face is in concentric relationship with the adjacent face of said lens. The optical axis of the lens can be oriented in parallel relationship with the optical axis of the geometrical ray path in the projection objective. The lens (L) can be arranged at the image side of a pupil (P) closest to the image plane or a system aperture (AS). The lens can be approximately hemispherical and the radius of the convex face differs from the lens thickness by below 20% of the iens thickness.

The image-side numerical aperture of the microlithography projection objective can be greater than 1.4, preferably greater than 1.6 and particularly preferably greater than 1.8.

In a further aspect, the invention features a microlithography projection exposure apparatus that includes a microlithography projection objective as set forth above, a light source, and an illumination system. The microlithography projection exposure apparatus can be arranged so that polarised light passes through the lenses (of uniaxial birefringent crystal). The polarised light can be tangentially polarised. The polarised light can be composed of linearly polarised beams.

### BRIEF DESCRIPTION OF THE DRAWINGS

The invention is described in greater detail hereinafter by means of embodiments by way of example with reference to the accompanying drawings in which:

FIGS. 1 to 4 are diagrammatic views of lens arrangements by way of example in accordance with the present invention, and

FIGS. 5 to 6 show objective designs by way of example in the lens section.

### DETAILED DESCRIPTION OF PREFERRED EMBODIMENTS

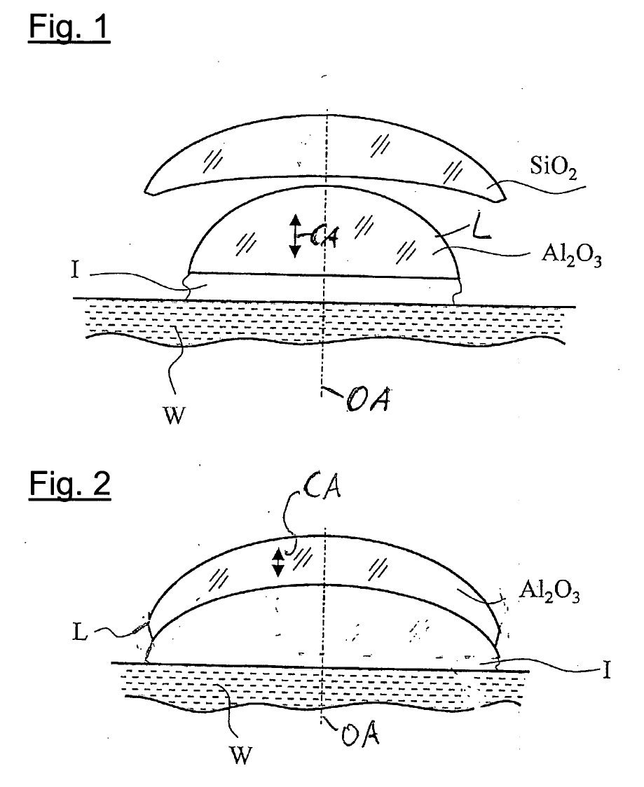

FIG. 1 diagrammatically shows an embodiment by way of example with a planoconvex lens L (of sapphire) with planar immersion I and a wafer W in the image plane. The optical axis OA of the projection objective and the crystal principal axis CA are parallel. FIG. 2 shows a variant with a meniscus lens L and similar references.

If in this respect the material of that last lens were completely isotropic, then after the last element there would be strictly tangentially polarised light, more specifically over the entire image field, although the light “etendue” is very high. What is the situation however for the conditions in the wafer or in the immersion or in the optical near field also applies exactly in the last optical element as long as, as shown above, the last optical face is almost planar or curved with an almost adapted refractive index in relation to the adjoining immersion. Tangential polarisation is also completely maintained in the last optical element, the chief rays to a:l image points in the image field extend in parallel relationship with the optical axis, and the coma rays (for the center of the image field the edge rays) are fully axially symmetrical with respect to the chief ray and thus telecentric.

Preferred characteristics of a microlithography projection objective of that kind are: telecentric at the image side, conformal (distortion-free) imaging and tangential polarisation in the object, in conjunction with a plane exit face or a non-plane refractive power-less exit face and the proviso that the other lenses in the objective comprise isotropic (non-birefringent materia)l give preference to a tangential polarisation state which is symmetrical with respect to the optical axis, in the last element. Further, more trivial preferred characteristics are a plane object and plane image and an orientation of the optical axis being in perpendicular relationship with the object and image. Now, to satisfy those conditions, the hypothetical, fully isotropic, last element is replaced by an element comprising a real uniaxial crystal, having the extreme refractive indices nₒ and nₑ. The crystallographic principal axis of the uniaxial crystal is so oriented in the last optical element that it is almost parallel to the optical axis of the refractive or catadioptric objective. With the exception of a narrow region around the optical axis in which nₒ=nₑ and in respect of which the tangential polarisation is not defined, exclusively nₒ now acts as the refractive index in the last optical element. It is therefore possible in the optical calculation to reckon exclusively with that refractive index nₒ which is isotropic to a good approximation and the system can be optimised.

If consideration is given to the conditions shortly before the first face of the last lens, they are high complex. It is only refraction at the entrance face itself that turns the polarisation direction in such a way that clean tangential polarisation occurs around each chief ray. So that now that rotation and transformation of that preliminary state prior to the first refractive face of the last element is prepared as isotropically as possible, there is proposed an isotropic layer whose refractive index is now so set that it corresponds to the refractive index which acts under tangential polarisation in the uniaxial crystal. That is substantially the refractive index of the ordinary ray nₒ. The thickness of the layer should exceed the ranges of the evanescent waves passing in the medium under the surface (from total reflection).

That signifies for the preferred thickness:

$$d \geq \frac{4 λ}{n}$$

A thickness for 193 nm and n=1.8 should therefore be or exceed about 200-400 nm.

It is therefore proposed in accordance with the invention that a layer of an isotropic material which is adapted in respect of refractive index is disposed on the lens according to the invention comprising optically uniaxial crystal. For that purpose amorphous layers of the materials specified here can be applied using known thin film technologies. Immersion fluid can also be considered. That layer therefore causes refraction and in that case rotation of the polarisation direction and refractive power-less transiting of the interface from the isotropic layer to the crystal lens.

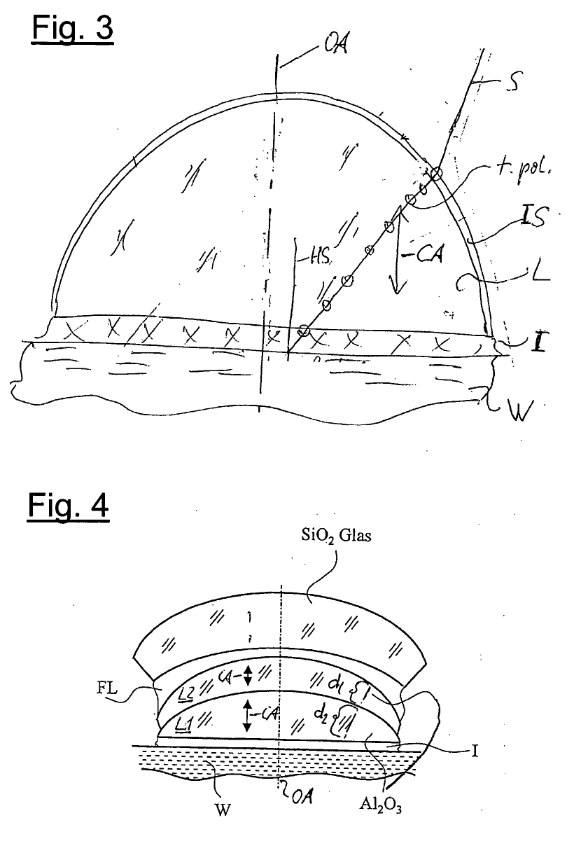

FIG. 3 diagrammatically shows that situation: IS is the layer of isotropic material. S is a light ray while “t. pol.” denotes its tangential polarisation (after refraction at IS). HS is the associated chief ray. The other references bear the same significances as in the preceding Figures.

After the isotropic layer upon entry into the uniaxial crystal there is practically no further refraction and no further rotation of the polarisation direction. Rotation of the polarisation direction upon refraction at the isotropic medium takes place only outside the main cuts. As long as the axis of rotation of the lens—it is preferably in coincident relationship with the optical axis of the system—and the incident and the refracted ray are in one plane at the same time, no rotation of locally linearly polarised light takes place. The tangentially polarised light is a preferred form of the locally linearly polarised light. It is crucial that in the crystal only tangentially polarised light is operative and tangential polarisation—in spite of real crystal dislocations and further interference effects which will not be further discussed in detail here—can be transported into the resist in the image plane.

The spatial dispersion in the case of uniaxial crystals with which the great birefringence effect (that is to say difference between nₒ and nₑ) is described is generally known. Symmetry prevails around the crystallographic principal axis, also referred to as the ‘optical axis of the crystal’ (this is not to be confused with the ‘optical axis of the projection objective’). The shape of the wave face for a crystal with an optically negative character (nₑ<nₒ) is a flattened rotational ellipsoid. With an optically positive character (nₑ>nₒ) it is a elongated rotational ellipsoid. The uniaxial crystals belong either to the trigonal (rhombohedral), hexagonal or tetragonal crystal system. The structure of the uniaxial crystals however is not rotationally symmetrical but the crystallographic principal axis or optical axis of the material represents a rotational invariance axis. After a rotation about a crystal-specific angle (trigonal=120°, tetragonal=90°, hexagonal=60°), the result is a completely identical orientation of the crystal structure. There is an additional spatial dispersion between those rotations about the optical axis of the crystal with the completely identical orientation. That is quite considerably less than the difference between nₒ and nₑ and in the normal case evades observability as the phase differences of nₒ and nₑ cover over everything. For lithographic applications those additional spatial dispersions however are harmful under some circumstances and then have to be observed and correctly compensated. That additional spatial dispersion is referred to hereinafter as ASD. By virtue of the crystal structure it provides that the simplified representation of the ray face of a rotational ellipsoid for nₑ and a spherical face for nₒ must be replaced, having regard to the weak effects of the additional spatial dispersion ASD, by a deformed rotational ellipsoid and a deformed spherical face. The systematology thereof, having regard to ASD, around the crystallographic principal axis, exhibits a 3-wave refractive index configuration for p=3, that is to say trigonal, a 4-wave refractive index configuration for p=4, that is to say tetragonal, and a 6-wave refractive index configuration for p=6, that is to say hexagonal. That wave nature of the refractive index is there both for nₑ and also for nₒ. The proposed particular use of the uniaxial crystals and maintaining the above-mentioned and claimed secondary conditions means that only nₒ is effective. Compensation of those influences of ASD is now also proposed in accordance with the invention. For that purpose an originally one-part lens comprising a single crystal is made in two or more parts. The claimed rule for the uniaxial crystals now provides for compensation of the additional spatial dispersion ASD of optical elements of crystals of the trigonal (p=3), tetragonal (p=4) and hexagonal (p=6) crystal system with parallelisation of the crystallographic principal axis in relation to the optical axis of the lithographic objective, by implementing a sequential arrangement of the elements, in succession or in a conjugate location, more specifically in such a way that the optical paths and angle configurations substantially correspond to each other and a rotation about the axis of symmetry of ≈360°/2p is effected. For the trigonal system that signifies a rotation of ≈60°, for the tetragonal system ≈45° and for the hexagonal system ≈30°.

FIG. 4 diagrammatically shows that arrangement. Here a fluid FL (immersion fluid) is provided in the intermediate space in relation to the preceding lens, here comprising SiO₂ (quartz) glass. The thicknesses d₁ and d₂ which a light beam passes through in both lens elements L1, L2 are of similar magnitude. The crystals which form L1 and L2, as described above, are rotated relative to each other about the optical axis of birefringence (crystal axis).

There is also a rhombohedral variant. Compensation takes place as in the trigonal system by a rotation also through 60°. The lens elements can be wrung together. Perpendicularly to the crystallographic principal axis thermal expansion is rotationally symmetrical identical even if possibly slightly modulated. That allows a stable wringing connection. A further way of connecting the crystal elements, besides wringing them together, is proposed for such an assembly:

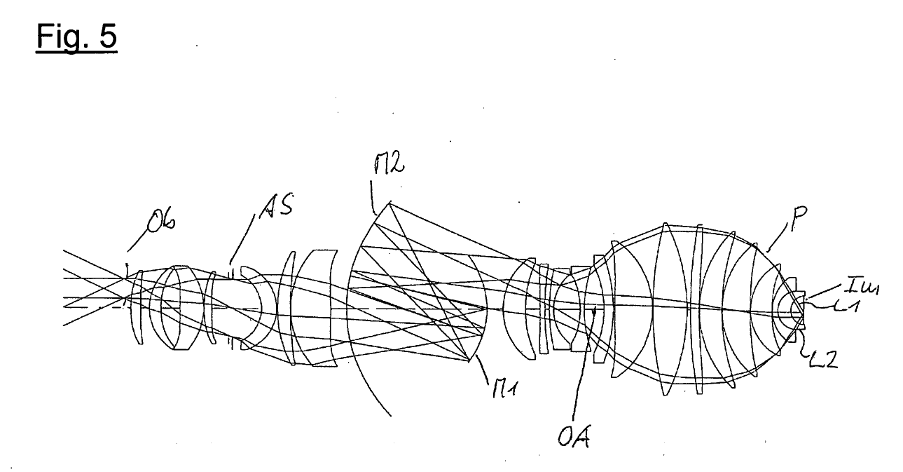

by adding a thin immersion (fluid layer) whose refractive index must be so high that total reflection does not occur (see FIG. 5 and Table 1),

by optical coupling by way of an optical near field, wherein the spacing of the two partners is preferably ≦λ/10 of the exposure wavelength used.

Aspects of the invention therefore concern strict telecentry in an uncompensated uniaxial crystal; almost equally good telecentry in a compensated packet: comprising two partial lenses with orientation of the principal axis in parallel relationship with the objective axis, wherein the two lenses are rotated specifically relative to each other about their principal axes; the application of an isotropic cover layer for rotation of the (locally) linear polarisation in order to achieve tangential polarisation in the lens according to the invention of crystal. Further advantages are the simultaneous use of tangential polarisation with immersion or near field; and the use of highly refractive (uniaxial) crystals with refractive indices of greater than 1.7. They include in particular the uniaxial crystals listed hereinafter.

The present invention differs from above-quoted WO 2005/059645 A2 inter alia in that the large refractive index difference between nₒ and nₑ is not compensated, but rather there are provided conditions which make it possible to dispense therewith. Only the much smaller additional spatial dispersion ASD of the uniaxial crystal components is optionally compensated by rotated installation.

Proposed hereinafter are uniaxial birefringent crystals with a high refractive index and adequate transmission for lithography at up to 193 nm as a material of lenses, plates, prisms etc, in particular as the last lens element in a refractive or catadioptric projection objective. In this respect the recommendation is for technical single crystals which have impurities and flaws in the crystal structure only to a slight extent. The material properties referred to hereinafter (refractive indices etc) are specified to the best of the inventor's knowledge but serve only for information purposes and are not binding.

| | | |
|---|---|---|
| Tetragonal crystal type: | | |
| Akermanite Ca₂MgSi₂O₇ | | |
| (alternatively written: 2CaO.MgO.SiO₂) | | |
| Density 2.94 g/cm³ | | |
| Mohs hardness 5.5 | | |
| nₒ = 1.6392, nₑ = 1.6431 for 589.3 nm | | |
| Structure type: Mellite | | |
| Gehlenite Ca₂Al₂SiO₇ | nₒ = 1.687 | at 589 nm |
| (alternatively written: | nₑ = 1.658 | |
| 2CaO.Al₂O₃.SiO₂) | | |
| Density 3.04 g/cm³ | | |
| Mohs hardness 5.5 | | |
| Structure type: Mellite | | |
| Beryllium Be₃Al₂(SiO₃)₆ | nₒ = 1.582 | at 589 nm |
| (alternatively written: | nₑ = 1.589 | |
| 3BeO.Al₂O₃.6SiO₂) | | |
| Density 2.64 g/cm³ | | |
| Mohs hardness: 7.8 | | |
| Structure type: Beryllium | | |
| Apatite Ca₅ (Po₄)₃ (OH, F, Cl) | nₒ = 1.645 | at 589 nm |
| | nₑ = 1.648 | |
| Density 3.2 g/cm³ | | |
| Mohs hardness: 5.0 | | |
| Terbium fluoride TbF₃ | nₒ = 1.6034 | at 589 nm |
| | nₑ = 1.5603 | |
| Hexagonal crystal type | | |
| (nₒ, nₑ in each case at 589 nm) | | |
| Beryllium oxide BeO | nₒ = 1.7184 | |
| | nₑ = 1.7342 | |
| Cerium fluoride CeF₃ | nₒ = 1.7184 | |
| | nₑ = 1.7342 | |
| Neodymium fluoride NdF₃ | nₒ = 1.605 | |
| | nₑ = 1.599 | |
| Praseodymium fluoride TbF₃ | nₒ = 1.6207 | |
| | nₑ = 1.6146 | |
| Lanthanum fluoride LaF₃ | nₒ = 1.605 | |
| | nₑ = 1.599 | |

Sapphire is to be considered as a special material in that crystal group. Sapphire has an extremely large band gap so that the transmission range in UV extends down to 157 nm. The refractive indices for sapphire are as follows (in relation to air):

| | | |
|---|---|---|
| 589.2938 nm | nₒ = 1.768077 | nₒ − nₑ = −0.008075 |
| | nₑ = 1.760002 | |
| 248.338 nm | nₒ = 1.846666 | nₒ − nₑ = −0.009763 |
| | nₑ = 1.836903 | |
| 193.304 nm | nₒ = 1.928032 | nₒ − nₑ = −0.011346 |
| | nₑ = 1.916686 | |
| 157.629 nm | | nₒ − nₑ = −0.012973 |

| | | |
|---|---|---|
| Trigonal crystal type in rhombohedral | | |
| system: (nₒ, nₑ in each case at 589 nm) | | |
| AIPO₄ | nₒ = 1.5247 | |
| | nₑ = 1.5338 | |
| Rhombohedral uniaxial crystal: | | |
| Dolomite CaMg(CO₃)₂ | nₒ = 1.6799 | |
| | nₑ = 1.5013 | |
| Phenakite BeSiO₄ | nₒ = 1.6538 | at 589.3 nm |
| | nₑ = 1.6695 | |
| Density: 2.98 | | |
| Hardness: 7.5 | | |
| Lithium nitrate LiNO₃ | nₒ = 1.735 | at 589.3 nm |
| (water-soluble) | nₑ = 1.435 | |
| Tetragonal uniaxial crystal: | | |
| Chloromagnesite MgCl₂ | nₒ = 1.675 | at 589.3 nm |
| (highly hygroscopic!) | nₑ = 1.590 | |
| Fluoroapatite Ca₅O[(PO₄)₃]F | nₒ = 1.63353 | at 589.3 nm |
| (synthetic) | nₑ = 1.63162 | |
| Al₈O₁₇Sr₅ | nₒ = 1.644 | at 589.3 nm |
| | nₑ = 1.638 | |
| Taaffeite Al₄MgBeO₈ | nₒ = 1.7230 | at 589.3 nm |
| | nₑ = 1.7182 | |

The residual deviations, which are not balanced out after compensation by a plurality of lens elements, at symmetrical and asymmetrical and manifold phase shifts, are considerably less than without compensation. Reference is made to the possibility of further compensating for uncompensated contributions by deformation (shaping for example by IBF or bending etc) of lenses or mirror surfaces. That is a clear definite procedure as the residual errors are polarisation-independent and they can be virtually isotropically corrected. A partial aperture which is particularly good to correct is formed by the outermost poles of the aperture (therefore for quadropole or dipole). In that way the optimisation range and the compensation range of the amorphous lenses and the uniaxial crystalline lenses according to the invention can be further advantageously limited. Furthermore it may be advantageous, in the rotation of the lens elements, with the various types of crystals, to deviate according to plan in dependence on the structure of the crystal as the rotational inversion axis can admittedly be exactly reproduced, but the compensation angle can differ from half the rotational inversion angle.

The high refractive index for example of sapphire at 193 nm of nₒ=1.928 makes it possible to build a high total aperture in respect of the lithographic projection objective and in that case to keep the volume of the optical materials (of the lenses) limited. A difference of preferably at least 0.15 to 0.20 between the refractive index of the material of the last lens relative to the value of the image-side numerical aperture of the projection objective is suitable to keep the lens volume really low (here sapphire n≈1.92 with NA=1.67 (Δ=0.25) in the embodiment of Table 1 and FIG. 5).

For 193 nm uniaxial sapphire is particularly significant, for 248 nm as the operating wavelength uniaxial aluminum nitride is to be added to the foregoing material listing. That too has a particularly high band gap. Admittedly it is no longer well transmissive for 193 nm but in return at 248 nm it affords an extremely high refractive index with adequate transmission.

The refractive indices for aluminum nitride AlN (related to air) are:

| | | |
|---|---|---|
| 589.2938 nm | nₒ = 2.1541 | nₒ − nₑ = +0.0459 |
| | nₑ = 2.2000 | |
| 248.338 nm | nₒ = 2.4030 | nₒ − nₑ = +0.1010 |
| | nₑ = 2.5040 | |

The example of FIG. 5 and Tables 1 and 2 show a lithographic projection objective with an image-side numerical aperture NA=1.670. The reduction factor (imaging scale) is 0.25. The objective is doubly telecentric in very substantial correction mode. Exact telecentry was selected at the reticle side (object side) for a mean height above the optical axis within the annular image field so that there are minimum plus and minus deviations around exact telecentry. The last lens is of the uniaxial crystal sapphire and is cleaved here for example for compensation in respect of spatial dispersion. By way of example an immersion is also introduced between sapphire and quartz glass, the refractive index of the immersion here being close to quartz glass and permitting optical contact. Immersion fluids with a refractive index of adjustable magnitude are known inter alia for example in the form of sulfuric or phosphoric acid in varying concentration. Wringing together or an air gap are also possible. When the air gap is involved, effects are afforded in terms of correction, while when wringing together is involved the different coefficient of expansion of sapphire in relation to glass is to be taken into consideration. The divided sapphire lens is wrung together in the example, it can also be coupled by way of an immersion or by way of an optical near field. The example clearly indicates how the image-side numerical aperture of the projection objective can be dramatically increased with clever aspherics use (double, triple, quadruple, quintuple and sextuple aspherics) and the use of a highly refractive, optically uniaxial crystal, here sapphire. The image field is extra-axially 4.0×22.0 mm². Extra-axiality is 4.375 nm. Imaging is almost distortion-free and for the wavefront quality reaches a value of below 12 milli-lambda with respect to the operating wavelength of 193.304 nm.

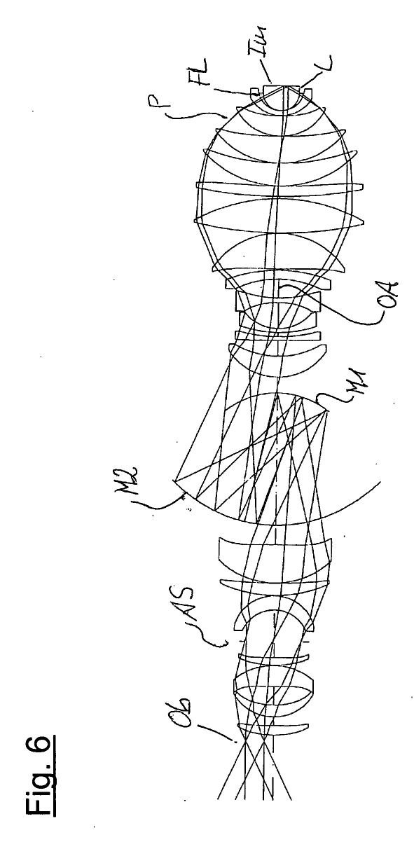

In FIG. 5 and Table 1 ‘Ob’ denotes the objective plane (the reticle or mask is arranged here). The starting point involved in the design is a telecentric entrance situation by virtue of illumination. AS identifies the system diaphragm, suitable for a physical, adjustable diaphragm. M1 and M2 identify two mirrors of the catadioptric objective. P identifies the position of a further pupil, the pupil closest to the image plane ‘Im’. L1 and L2 identify the two lens elements, which are rotated relative to each other about the crystal axis, of the lens according to the invention comprising optically uniaxial crystal. FL (only in FIG. 6) is a fluid between the last quartz glass lens and L2. Im is the image plane, here as near field coupling, with a minimum spacing relative to the lens L1 below the wavelength of the light (193 nm) for which operation of this objective is intended in a projection exposure system which is known per se in respect of the further parts thereof. OA is the optical axis of the projection objective.

In principle the arrangement of L2, L1 and Im corresponds to that in FIG. 4, although without immersion I at the wafer W. The quartz glass lens in front of L2 is here concentric with its adjoining surface 43, in relation to the adjacent surface 44. Mutually matching aspherics are also advantageous here.

FIG. 6 and Tables 3 and 4 show a further design example with a further increased numerical aperture of 1.70 and a one-piece lens according to the invention directly at the image plane. The wavefront error is specified at 13 milli-lambda. The structural length from ‘Ob’ to ‘Im’ is 1269 mm.

The above description of preferred embodiments has been given by way of example. A person skilled in the art will, however, not only understand the present invention and its advantages, but will also find suitable modifications thereof. Therefore, the present invention is intended to cover all such changes and modifications as far as falling within the spirit and scope of the invention as defined in the appended claims and the equivalents thereof.

TABLE 1
(Design data for FIG. 5):

| | | | | | refractive index | ½ free |
|---|---|---|---|---|---|---|
| Surface | | Radii | Thicknesses | Material | (132.304 nm) | diameter |
| 0 | Ob | ∞ | 12.264654533 | | 1.00000000 | 52.000 |
| 1 | | 193.317109771AS | 18.079133108 | SIO2 | 1.56028895 | 64.135 |
| 2 | | 1605.405087600AS | 16.113546059 | | 1.00000000 | 64.458 |
| 3 | | 86.791846314AS | 21.158872132 | SIO2 | 1.56028895 | 72.042 |
| 4 | | 129.163251451AS | 35.473470508 | | 1.00000000 | 69.332 |
| 5 | | 2629.642039740AS | 43.522318555 | SIO2 | 1.56028895 | 69.101 |
| 6 | | −114.056113004 | 0.700000000 | | 1.00000000 | 73.076 |
| 7 | | 178.864572561AS | 14.220328265 | SIO2 | 1.56028895 | 63.104 |
| 8 | | 2800.058841850AS | 31.039821569 | | 1.00000000 | 60.382 |
| 9 | AS | ∞ | 60.200321557 | | 1.00000000 | 51.845 |
| 10 | | −67.175341414 | 27.761201107 | SIO2 | 1.56028895 | 59.892 |
| 11 | | −78.838979729 | 1.366382243 | | 1.00000000 | 72.831 |
| 12 | | 213.794308589AS | 23.812186212 | SIO2 | 1.56028895 | 99.818 |
| 13 | | 586.991140532 | 0.700000000 | | 1.00000000 | 99.794 |
| 14 | | 154.289058545 | 73.361297670 | SIO2 | 1.56028895 | 102.701 |
| 15 | | −903.888033320AS | 30.127631830 | | 1.00000000 | 92.743 |
| 16 | | 261.303497903 | 258.241251656 | | 1.00000000 | 86.343 |
| 17 | M1 | −148.836808963AS | −258.241251656 | | −1.00000000 | 94.882 |
| REFL | | | | | | |
| 18 | M2 | 261.304794265AS | 258.241251656 | | 1.00000000 | 190.661 |
| REFL | | | | | | |
| 19 | | ∞ | 29.735193783 | | 1.00000000 | 112.901 |
| 20 | | 114.032907536AS | 40.567098916 | SIO2 | 1.56028895 | 89.278 |
| 21 | | 203.325279145 | 26.647179640 | | 1.00000000 | 82.711 |
| 22 | | −1333.257100960AS | 8.753817736 | SIO2 | 1.56028895 | 78.925 |
| 23 | | 459.273514903 | 8.267042648 | | 1.00000000 | 74.579 |
| 24 | | 310.016833052AS | 7.503528278 | SIO2 | 1.56028895 | 71.025 |
| 25 | | 76.426348752AS | 49.107381928 | | 1.00000000 | 62.607 |
| 26 | | −163.776424186AS | 7.504494000 | SIO2 | 1.56028895 | 63.121 |
| 27 | | 205.944799889AS | 36.816792926 | | 1.00000000 | 75.141 |
| 28 | | −180.994364547 | 17.120395276 | SIO2 | 1.56028895 | 80.391 |
| 29 | | −281.468176595 | 2.534559199 | | 1.00000000 | 95.103 |
| 30 | | 2228.718324040AS | 69.490201660 | SIO2 | 1.56028895 | 112.197 |
| 31 | | −149.948483128 | 0.777699229 | | 1.00000000 | 120.398 |
| 32 | | 594.806884980AS | 62.809824352 | SIO2 | 1.56028895 | 151.892 |
| 33 | | −354.750574511 | 6.183635896 | | 1.00000000 | 153.034 |
| 34 | | 865.056417827 | 16.101945320 | SIO2 | 1.56028895 | 150.033 |
| 35 | | 874.081923252AS | 0.700000000 | | 1.00000000 | 149.173 |
| 36 | | 196.789899120 | 41.031518678 | SIO2 | 1.56028895 | 139.194 |
| 37 | | 361.321738378AS | 0.700000000 | | 1.00000000 | 135.877 |
| 38 | | 153.546195324 | 51.282148414 | SIO2 | 1.56028895 | 119.010 |
| 39 | | 651.746055424AS | 0.700000000 | | 1.00000000 | 113.570 |
| 40 | | 95.267259671AS | 39.493154245 | SI02 | 1.56028895 | 81.182 |
| 41 | | 249.425717436AS | 0.700000000 | | 1.00000000 | 73.350 |
| 42 | | 69.576656086AS | 9.970163858 | SIO2 | 1.56028895 | 56.710 |
| 43 | | 35.050833329 | 0.200000000 | IMMERSION | 1.56100000 | 35.050 |
| 44 | L1 | 34.850833329 | 23.705769537 | SAPHIR | 1.92803200 | 34.851 |
| 45 | L2 | 27.000000000 | 23.705268000 | SAPHIR | 1.92803200 | 24.993 |
| 46 | IM | ∞ | 0.000000000 | | | 13.000 |

TABLE 2
(Aspheric Constants for FIG. 5)
SURFACE NR. 1

| | |
|---|---|
| K | 0.0000 |
| C1 | 1.73129117e−007 |
| C2 | 2.25514886e−011 |
| C3 | −7.99695881e−015 |
| C4 | 1.03685919e−018 |
| C5 | −2.33156500e−023 |
| C6 | −5.97415924e−027 |
| C7 | 0.00000000e+000 |
| C8 | 0.00000000e+000 |
| C9 | 0.00000000e+000 |

SURFACE NR. 2

| | |
|---|---|
| K | 0.0000 |
| C1 | 1.78579815e−007 |
| C2 | −2.33870161e−012 |
| C3 | −3.46118106e−015 |
| C4 | 1.46375514e−019 |
| C5 | 1.01396852e−022 |
| C6 | −1.46376823e−026 |
| C7 | 0.00000000e+000 |
| C8 | 0.00000000e+000 |
| C9 | 0.00000000e+000 |

SURFACE NR. 3

| | |
|---|---|
| K | 0.0000 |
| C1 | −1.66395697e−008 |
| C2 | −2.36409509e−012 |
| C3 | −4.48432661e−017 |
| C4 | −5.47548356e−020 |
| C5 | 9.62108884e−024 |
| C6 | −7.49518959e−028 |
| C7 | 0.00000000e+000 |
| C8 | 0.00000000e+000 |
| C9 | 0.00000000e+000 |

SURFACE NR. 4

| | |
|---|---|
| K | 0.0000 |
| C1 | 3.67287858e−010 |
| C2 | 3.75673299e−011 |
| C3 | −2.70023165e−015 |
| C4 | 3.71744076e−019 |
| C5 | −3.06524260e−023 |
| C6 | 5.46359243e−027 |
| C7 | 0.00000000e+000 |
| C8 | 0.00000000e+000 |
| C9 | 0.00000000e+000 |

SURFACE NR. 5

| | |
|---|---|
| K | 0.0000 |
| C1 | −1.91610579e−007 |
| C2 | −1.04854745e−010 |
| C3 | 2.08620472e−014 |
| C4 | −2.51441201e−018 |
| C5 | 1.76029456e−022 |
| C6 | −6.40357866e−027 |
| C7 | 0.00000000e+000 |
| C8 | 0.00000000e+000 |
| C9 | 0.00000000e+000 |

SURFACE NR. 7

| | |
|---|---|
| K | 0.0000 |
| C1 | 6.20158168e−010 |
| C2 | 3.33289304e−011 |
| C3 | 2.98431778e−016 |
| C4 | 1.26017048e−018 |
| C5 | −4.47624183e−022 |
| C6 | 4.27258087e−026 |
| C7 | 0.00000000e+000 |
| C8 | 0.00000000e+000 |
| C9 | 0.00000000e+000 |

SURFACE NR. 8

| | |
|---|---|
| K | 0.0000 |
| C1 | 2.74800329e−007 |
| C2 | 2.70723874e−011 |
| C3 | 5.48812824e−015 |
| C4 | 1.65502782e−018 |
| C5 | −4.00753019e−022 |
| C6 | 4.84628721e−026 |
| C7 | 0.00000000e+000 |
| C8 | 0.00000000e+000 |
| C9 | 0.00000000e+000 |

SURFACE NR. 12

| | |
|---|---|
| K | 0.0000 |
| C1 | −1.16576204e−008 |
| C2 | 1.35738980e−012 |
| C3 | 1.63199824e−017 |
| C4 | −3.61784945e−021 |
| C5 | 1.57944321e−025 |
| C6 | −2.10944829e−030 |
| C7 | 0.00000000e+000 |
| C8 | 0.00000000e+000 |
| C9 | 0.00000000e+000 |

SURFACE NR. 15

| | |
|---|---|
| K | 0.0000 |
| C1 | 1.46181601e−007 |
| C2 | 9.16790051e−013 |
| C3 | −6.42816110e−017 |
| C4 | 3.83030739e−021 |
| C5 | −2.44726998e−025 |
| C6 | 2.50846957e−029 |
| C7 | 0.00000000e+000 |
| C8 | 0.00000000e+000 |

SURFACE NR. 17

| | |
|---|---|
| K | −0.0416 |
| C1 | 1.83751696e−008 |
| C2 | 6.27668402e−013 |
| C3 | −4.62764067e−018 |
| C4 | 2.89456125e−021 |
| C5 | −1.51883971e−025 |
| C6 | 6.11390860e−030 |
| C7 | 0.00000000e+000 |
| C8 | 0.00000000e+000 |
| C9 | 0.00000000e+000 |

SURFACE NR. 18

| | |
|---|---|
| K | −0.2288 |
| C1 | −2.92934776e−010 |
| C2 | −3.44445539e−015 |
| C3 | −2.39326701e−020 |
| C4 | −1.79006210e−024 |
| C5 | 3.06667427e−029 |
| C6 | −4.95001842e−034 |
| C7 | 0.00000000e+000 |
| C8 | 0.00000000e+000 |
| C9 | 0.00000000e+000 |

SURFACE NR. 20

| | |
|---|---|
| K | 0.0000 |
| C1 | 4.22360586e−010 |
| C2 | 4.70842117e−013 |
| C3 | −1.02394195e−016 |
| C4 | 1.63183462e−020 |
| C5 | −1.52893785e−024 |
| C6 | 1.04681878e−028 |
| C7 | 0.00000000e+000 |
| C8 | 0.00000000e+000 |
| C9 | 0.00000000e+000 |

SURFACE NR. 22

| | |
|---|---|
| K | 0.0000 |
| C1 | 5.53956695e−008 |
| C2 | 5.02859524e−013 |
| C3 | −1.49876376e−015 |
| C4 | 3.54064826e−019 |
| C5 | −3.19320407e−023 |
| C6 | 1.12826300e−027 |
| C7 | 0.00000000e+000 |
| C8 | 0.00000000e+000 |
| C9 | 0.00000000e+000 |

SURFACE NR. 24

| | |
|---|---|
| K | 0.0000 |
| C1 | −3.25890503e−008 |
| C2 | 1.76593891e−011 |
| C3 | −2.82606495e−016 |
| C4 | −1.04352459e−018 |
| C5 | 1.28467243e−022 |
| C6 | −4.30021973e−027 |
| C7 | 0.00000000e+000 |
| C8 | 0.00000000e+000 |

SURFACE NR. 25

| | |
|---|---|
| K | 0.0000 |
| C1 | −1.49659052e−007 |
| C2 | 1.42538094e−011 |
| C3 | 5.44729531e−016 |
| C4 | −1.32571908e−018 |
| C5 | 4.48344936e−023 |
| C6 | −2.16805082e−026 |
| C7 | 0.00000000e+000 |
| C8 | 0.00000000e+000 |
| C9 | 0.00000000e+000 |

SURFACE NR. 26

| | |
|---|---|
| K | 0.0000 |
| C1 | −1.65667610e−007 |
| C2 | −4.64637437e−012 |
| C3 | −2.13841896e−015 |
| C4 | 1.47866850e−019 |
| C5 | −2.24141505e−023 |
| C6 | −1.26338726e−028 |
| C7 | 0.00000000e+000 |
| C8 | 0.00000000e+000 |
| C9 | 0.00000000e+000 |

SURFACE NR. 27

| | |
|---|---|
| K | 0.0000 |
| C1 | 2.86792032e−008 |
| C2 | −1.09490027e−011 |
| C3 | −4.41517226e−015 |
| C4 | 1.10425254e−018 |
| C5 | −9.80269742e−023 |
| C6 | 3.34710160e−027 |
| C7 | 0.00000000e+000 |
| C8 | 0.00000000e+000 |
| C9 | 0.00000000e+000 |

SURFACE NR. 30

| | |
|---|---|
| K | 0.0000 |
| C1 | −3.92937981e−008 |
| C2 | 3.35619147e−013 |
| C3 | −2.57040365e−017 |
| C4 | −5.84456071e−022 |
| C5 | 9.37385161e−026 |
| C6 | −5.81452027e−030 |
| C7 | 0.00000000e+000 |
| C8 | 0.00000000e+000 |
| C9 | 0.00000000e+000 |

SURFACE NR. 32

| | |
|---|---|
| K | 0.0000 |
| C1 | −1.63376129e−010 |
| C2 | 7.01879988e−016 |
| C3 | 2.55063758e−019 |
| C4 | −1.61889145e−023 |
| C5 | 1.41287956e−028 |
| C6 | −2.06794180e−032 |
| C7 | 0.00000000e+000 |
| C8 | 0.00000000e+000 |

SURFACE NR. 35

| | |
|---|---|
| K | 0.0000 |
| C1 | −1.12588664e−008 |
| C2 | 6.03267650e−014 |
| C3 | −8.15175168e−018 |
| C4 | −2.79077345e−022 |
| C5 | 1.54793732e−026 |
| C6 | −1.99068685e−031 |
| C7 | 0.00000000e+000 |
| C8 | 0.00000000e+000 |
| C9 | 0.00000000e+000 |

SURFACE NR. 37

| | |
|---|---|
| K | 0.0000 |
| C1 | −3.40446117e−009 |
| C2 | −2.12825506e−013 |
| C3 | −1.42387641e−018 |
| C4 | −3.97234840e−023 |
| C5 | 9.99346340e−027 |
| C6 | −2.49986314e−032 |
| C7 | 0.00000000e+000 |
| C8 | 0.00000000e+000 |
| C9 | 0.00000000e+000 |

SURFACE NR. 39

| | |
|---|---|
| K | 0.0000 |
| C1 | 6.97904946e−009 |
| C2 | 1.49117505e−013 |
| C3 | 1.00373407e−016 |
| C4 | −6.60000850e−021 |
| C5 | 2.50770985e−025 |
| C6 | −4.22790895e−030 |
| C7 | 0.00000000e+000 |
| C8 | 0.00000000e+000 |
| C9 | 0.00000000e+000 |

SURFACE NR. 40

| | |
|---|---|
| K | 0.0000 |
| C1 | 2.00813460e−008 |
| C2 | 1.79942840e−012 |
| C3 | 1.23568248e−016 |
| C4 | 1.65521590e−020 |
| C5 | −9.75858246e−025 |
| C6 | 4.31778603e−028 |
| C7 | 0.00000000e+000 |
| C8 | 0.00000000e+000 |
| C9 | 0.00000000e+000 |

SURFACE NR. 41

| | |
|---|---|
| K | 0.0000 |
| C1 | 1.38726199e−007 |
| C2 | 2.04561010e−012 |
| C3 | 5.63821936e−016 |
| C4 | −3.60894957e−020 |
| C5 | 1.40718591e−025 |
| C6 | −2.99947351e−029 |
| C7 | 0.00000000e+000 |
| C8 | 0.00000000e+000 |

SURFACE NR. 42

| | |
|---|---|
| K | 0.0000 |
| C1 | −7.34587476e−008 |
| C2 | −1.63990463e−011 |
| C3 | −2.04758605e−015 |
| C4 | −2.72487557e−019 |
| C5 | 2.31944679e−022 |
| C6 | −2.30842777e−026 |
| C7 | 0.00000000e+000 |
| C8 | 0.00000000e+000 |
| C9 | 0.00000000e+000 |

TABLE 3
(Design data for FIG. 6):

| | | | | refractive index | ½ free |
|---|---|---|---|---|---|
| Surface | Radii | Thicknesses | Material | (132.304 nm) | diameter |
| 0 | 0.000000000 | 11.911810809 | | 1.00000000 | 52.000 |
| 1 | 208.986285831AS | 17.615545822 | SIO2 | 1.56028895 | 64.049 |
| 2 | 1749.121989423AS | 16.937657371 | | 1.00000000 | 64.433 |
| 3 | 87.091117479AS | 22.488230722 | SIO2 | 1.56028895 | 73.169 |
| 4 | 133.222297131AS | 36.630361899 | | 1.00000000 | 70.192 |
| 5 | 1918.989589202AS | 40.332183479 | SIO2 | 1.56028895 | 69.934 |
| 6 | −116.327559576 | 0.700000000 | | 1.00000000 | 73.345 |
| 7 | 202.550131782AS | 14.705075849 | SIO2 | 1.56028895 | 64.058 |
| 8 | −1589.760095366AS | 31.039821569 | | 1.00000000 | 61.728 |
| 9 | 0.000000000 | 60.200321557 | | 1.00000000 | 53.057 |
| 10 | −66.253612556 | 27.438664599 | SIO2 | 1.56028895 | 60.365 |
| 11 | −78.800931388 | 0.700000000 | | 1.00000000 | 73.618 |
| 12 | 233.110236076AS | 24.752174859 | SIO2 | 1.56028895 | 101.020 |
| 13 | 835.927849735 | 0.700000000 | | 1.00000000 | 101.119 |
| 14 | 154.356844191AS | 73.365350978 | SIO2 | 1.56028895 | 104.275 |
| 15 | −948.808190693AS | 37.496136409 | | 1.00000000 | 94.183 |
| 16 | 260.938328939 | 257.309816533 | | 1.00000000 | 86.383 |
| 17 | −148.285380258AS | −257.309816533 | | −1.00000000 | 96.386 |
| REFL | | | | | |
| 18 | 260.985854680AS | 257.309816533 | | 1.00000000 | 194.737 |
| REFL | | | | | |
| 19 | 0.000000000 | 30.832301913 | | 1.00000000 | 116.379 |
| 20 | 109.802485970AS | 40.273387899 | SIO2 | 1.56028895 | 89.774 |
| 21 | 158.157127594 | 30.349960093 | | 1.00000000 | 81.805 |
| 22 | 7971.146822910AS | 7.500000000 | SIO2 | 1.56028895 | 78.091 |
| 23 | 271.696924487 | 8.076613987 | | 1.00000000 | 73.563 |
| 24 | 218.344284722AS | 7.500000000 | SIO2 | 1.56028895 | 70.778 |
| 25 | 78.683867539AS | 50.097781507 | | 1.00000000 | 63.371 |
| 26 | −163.773513934AS | 8.754435512 | SIO2 | 1.56028895 | 63.999 |
| 27 | 200.903100402AS | 36.613836665 | | 1.00000000 | 77.716 |
| 28 | −184.740564669AS | 17.040530308 | SIO2 | 1.56028895 | 82.216 |
| 29 | −284.566932026 | 2.407644391 | | 1.00000000 | 97.150 |
| 30 | 1685.316623358AS | 69.452650706 | SIO2 | 1.56028895 | 116.262 |
| 31 | −152.529885090 | 0.700000000 | | 1.00000000 | 123.139 |
| 32 | 664.378763319AS | 66.689863979 | SIO2 | 1.56028895 | 157.453 |
| 33 | −337.600432374 | 4.143043366 | | 1.00000000 | 158.766 |
| 34 | 796.031919508 | 19.736732865 | SIO2 | 1.56028895 | 156.016 |
| 35 | 850.497416708AS | 0.700000000 | | 1.00000000 | 154.992 |
| 36 | 197.269782088 | 43.272216879 | SIO2 | 1.56028895 | 143.254 |
| 37 | 357.139089289AS | 0.700000000 | | 1.00000000 | 139.742 |
| 38 | 155.440930333 | 51.782743980 | SIO2 | 1.56028895 | 121.610 |
| 39 | 618.676875093AS | 0.700000000 | | 1.00000000 | 115.965 |
| 40 | 97.485803850AS | 39.302884352 | SIO2 | 1.56028895 | 82.312 |
| 41 | 241.905361187AS | 0.700000000 | | 1.00000000 | 74.732 |
| 42 | 66.330735532AS | 9.427204469 | SIO2 | 1.56028895 | 56.259 |
| 43 | 44.658683500 | 0.200000000 | IMM | 1.56100000 | 42.389 |
| 44 | 34.948083341 | 47.584354512 | SAPHIR | 1.92803200 | 34.948 |
| 45 | 0.000000000 | 0.000000000 | | 1.00000000 | 13.000 |

TABLE 4
(Aspheric constants for FIG. 6)
SURFACE NR. 1

| | |
|---|---|
| K | 0.0000 |
| C1 | 2.12540707e−007 |
| C2 | 2.76630129e−011 |
| C3 | −1.24097265e−014 |
| C4 | 1.98297295e−018 |
| C5 | −7.99913665e−023 |
| C6 | −1.02218183e−026 |
| C7 | 0.00000000e+000 |
| C8 | 0.00000000e+000 |
| C9 | 0.00000000e+000 |

SURFACE NR. 2

| | |
|---|---|
| K | 0.0000 |
| C1 | 2.08286600e−007 |
| C2 | −4.17354860e−012 |
| C3 | −4.88840552e−015 |
| C4 | 3.86956550e−019 |
| C5 | 1.50448515e−022 |
| C6 | −2.65397925e−026 |
| C7 | 0.00000000e+000 |
| C8 | 0.00000000e+000 |
| C9 | 0.00000000e+000 |

SURFACE NR. 3

| | |
|---|---|
| K | 0.0000 |
| C1 | 1.64083708e−008 |
| C2 | −6.40761217e−012 |
| C3 | 4.43806311e−016 |
| C4 | 1.07333244e−020 |
| C5 | −1.84658232e−024 |
| C6 | 2.36646597e−028 |
| C7 | 0.00000000e+000 |
| C8 | 0.00000000e+000 |
| C9 | 0.00000000e+000 |

SURFACE NR. 4

| | |
|---|---|
| K | 0.0000 |
| C1 | 3.69502924e−008 |
| C2 | 4.04277139e−011 |
| C3 | −3.45660412e−015 |
| C4 | 4.82644024e−019 |
| C5 | −2.19295000e−023 |
| C6 | 3.17012267e−027 |
| C7 | 0.00000000e+000 |
| C8 | 0.00000000e+000 |
| C9 | 0.00000000e+000 |

SURFACE NR. 5

| | |
|---|---|
| K | 0.0000 |
| C1 | −1.91036827e−007 |
| C2 | −1.03379613e−010 |
| C3 | 2.10347941e−014 |
| C4 | −2.41489752e−018 |
| C5 | 1.30278243e−022 |
| C6 | −1.89224263e−027 |
| C7 | 0.00000000e+000 |
| C8 | 0.00000000e+000 |
| C9 | 0.00000000e+000 |

SURFACE NR. 7

| | |
|---|---|
| K | 0.0000 |
| C1 | 8.07948087e−009 |
| C2 | 3.46195897e−011 |
| C3 | −1.23866729e−015 |
| C4 | 1.20772169e−018 |
| C5 | −6.05829966e−022 |
| C6 | 5.76569676e−026 |
| C7 | 0.00000000e+000 |
| C8 | 0.00000000e+000 |
| C9 | 0.00000000e+000 |

SURFACE NR. 8

| | |
|---|---|
| K | 0.0000 |
| C1 | 2.83249589e−007 |
| C2 | 2.19674344e−011 |
| C3 | 4.56980674e−015 |
| C4 | 1.02895714e−018 |
| C5 | −4.09038924e−022 |
| C6 | 2.94628764e−026 |
| C7 | 0.00000000e+000 |
| C8 | 0.00000000e+000 |
| C9 | 0.00000000e+000 |

SURFACE NR. 12

| | |
|---|---|
| K | 0.0000 |
| C1 | −1.09915503e−008 |
| C2 | 1.48145437e−012 |
| C3 | 2.08248803e−017 |
| C4 | −4.07576638e−021 |
| C5 | 1.67045489e−025 |
| C6 | −2.49036950e−030 |
| C7 | 0.00000000e+000 |
| C8 | 0.00000000e+000 |
| C9 | 0.00000000e+000 |

SURFACE NR. 14

| | |
|---|---|
| K | 0.0000 |
| C1 | 8.18298434e−010 |
| C2 | 4.39060919e−014 |
| C3 | −3.93672459e−018 |
| C4 | 6.22981355e−023 |
| C5 | 1.15962628e−026 |
| C6 | −2.32051078e−030 |
| C7 | 0.00000000e+000 |
| C8 | 0.00000000e+000 |
| C9 | 0.00000000e+000 |

SURFACE NR. 15

| | |
|---|---|
| K | 0.0000 |
| C1 | 1.44099441e−007 |
| C2 | 7.48503423e−013 |
| C3 | −4.60542488e−017 |
| C4 | 3.78985671e−021 |
| C5 | −3.06060934e−025 |
| C6 | 1.83018598e−029 |
| C7 | 0.00000000e+000 |
| C8 | 0.00000000e+000 |
| C9 | 0.00000000e+000 |

SURFACE NR. 17

| | |
|---|---|
| K | −0.0599 |
| C1 | 1.71916933e−008 |
| C2 | 6.57041322e−013 |
| C3 | −9.80535117e−018 |
| C4 | 3.30644661e−021 |
| C5 | −1.70751496e−025 |
| C6 | 6.36044171e−030 |
| C7 | 0.00000000e+000 |
| C8 | 0.00000000e+000 |
| C9 | 0.00000000e+000 |

SURFACE NR. 18

| | |
|---|---|
| K | −0.2585 |
| C1 | −9.37461135e−011 |
| C2 | −5.51039232e−016 |
| C3 | −1.13354195e−020 |
| C4 | −7.59723154e−025 |
| C5 | 1.55691455e−029 |
| C6 | −2.50938619e−034 |
| C7 | 0.00000000e+000 |
| C8 | 0.00000000e+000 |
| C9 | 0.00000000e+000 |

SURFACE NR. 20

| | |
|---|---|
| K | 0.0000 |
| C1 | −3.61405036e−009 |
| C2 | 3.18153801e−013 |
| C3 | −1.25349931e−016 |
| C4 | 1.36966297e−020 |
| C5 | −1.25527933e−024 |
| C6 | 6.22649815e−029 |
| C7 | 0.00000000e+000 |
| C8 | 0.00000000e+000 |
| C9 | 0.00000000e+000 |

SURFACE NR. 22

| | |
|---|---|
| K | 0.0000 |
| C1 | 3.67999588e−008 |
| C2 | −6.02564016e−013 |
| C3 | −1.09544556e−015 |
| C4 | 3.44397137e−019 |
| C5 | −3.57960760e−023 |
| C6 | 1.44445676e−027 |
| C7 | 0.00000000e+000 |
| C8 | 0.00000000e+000 |
| C9 | 0.00000000e+000 |

SURFACE NR. 24

| | |
|---|---|
| K | 0.0000 |
| C1 | −4.41405341e−009 |
| C2 | 2.15865101e−011 |
| C3 | −1.29406741e−015 |
| C4 | −1.10816757e−018 |
| C5 | 1.45666050e−022 |
| C6 | −6.00347374e−027 |
| C7 | 0.00000000e+000 |
| C8 | 0.00000000e+000 |
| C9 | 0.00000000e+000 |

SURFACE NR. 25

| | |
|---|---|
| K | 0.0000 |
| C1 | −8.10438946e−008 |
| C2 | 2.11140947e−011 |
| C3 | 4.11967164e−016 |
| C4 | −1.43896108e−018 |
| C5 | 8.26925904e−023 |
| C6 | −1.60460177e−026 |
| C7 | 0.00000000e+000 |
| C8 | 0.00000000e+000 |
| C9 | 0.00000000e+000 |

SURFACE NR. 26

| | |
|---|---|
| K | 0.0000 |
| C1 | −1.32689710e−007 |
| C2 | −5.18029673e−012 |
| C3 | −2.43993535e−015 |
| C4 | 8.27283058e−020 |
| C5 | 5.00121165e−024 |
| C6 | −2.09397678e−027 |
| C7 | 0.00000000e+000 |
| C8 | 0.00000000e+000 |
| C9 | 0.00000000e+000 |

SURFACE NR. 27

| | |
|---|---|
| K | 0.0000 |
| C1 | 2.72316515e−008 |
| C2 | −1.16119693e−011 |
| C3 | −4.42367369e−015 |
| C4 | 1.10900216e−018 |
| C5 | −9.96121399e−023 |
| C6 | 3.40897992e−027 |
| C7 | 0.00000000e+000 |
| C8 | 0.00000000e+000 |
| C9 | 0.00000000e+000 |

SURFACE NR. 28

| | |
|---|---|
| K | 0.0000 |
| C1 | −1.24882483e−011 |
| C2 | 5.54737579e−013 |
| C3 | 8.02582742e−017 |
| C4 | −6.94425443e−021 |
| C5 | 9.35945635e−025 |
| C6 | −1.97328409e−029 |
| C7 | 0.00000000e+000 |
| C8 | 0.00000000e+000 |
| C9 | 0.00000000e+000 |

SURFACE NR. 30

| | |
|---|---|
| K | 0.0000 |
| C1 | −3.86405618e−008 |
| C2 | 3.67620590e−013 |
| C3 | −2.48789214e−017 |
| C4 | −5.24515079e−022 |
| C5 | 9.15133266e−026 |
| C6 | −5.15756513e−030 |
| C7 | 0.00000000e+000 |
| C8 | 0.00000000e+000 |
| C9 | 0.00000000e+000 |

SURFACE NR. 32

| | |
|---|---|
| K | 0.0000 |
| C1 | −2.71554874e−010 |
| C2 | −1.68138382e−015 |
| C3 | 2.31809813e−019 |
| C4 | −9.94960068e−024 |
| C5 | 5.47011148e−028 |
| C6 | −2.87510400e−032 |
| C7 | 0.00000000e+000 |
| C8 | 0.00000000e+000 |
| C9 | 0.00000000e+000 |

SURFACE NR. 35

| | |
|---|---|
| K | 0.0000 |
| C1 | −1.11621768e−008 |
| C2 | 6.34081953e−014 |
| C3 | −8.05048014e−018 |
| C4 | −2.79623435e−022 |
| C5 | 1.53154418e−026 |
| C6 | −1.89873340e−031 |
| C7 | 0.00000000e+000 |
| C8 | 0.00000000e+000 |
| C9 | 0.00000000e+000 |

SURFACE NR. 37

| | |
|---|---|
| K | 0.0000 |
| C1 | −3.24125304e−009 |
| C2 | −2.09312437e−013 |
| C3 | −1.33034047e−018 |
| C4 | −4.44578045e−023 |
| C5 | 9.48106329e−027 |
| C6 | −1.01931777e−032 |
| C7 | 0.00000000e+000 |
| C8 | 0.00000000e+000 |
| C9 | 0.00000000e+000 |

SURFACE NR. 39

| | |
|---|---|
| K | 0.0000 |
| C1 | 7.28165239e−009 |
| C2 | 1.75710778e−013 |
| C3 | 1.02379089e−016 |
| C4 | −6.52088581e−021 |
| C5 | 2.48726507e−025 |
| C6 | −3.98510293e−030 |
| C7 | 0.00000000e+000 |
| C8 | 0.00000000e+000 |
| C9 | 0.00000000e+000 |

SURFACE NR. 40

| | |
|---|---|
| K | 0.0000 |
| C1 | 3.04378024e−008 |
| C2 | 2.40124413e−012 |
| C3 | 1.64825394e−016 |
| C4 | 2.01625439e−020 |
| C5 | −7.32192396e−025 |
| C6 | 4.67028071e−028 |
| C7 | 0.00000000e+000 |
| C8 | 0.00000000e+000 |
| C9 | 0.00000000e+000 |

SURFACE NR. 41

| | |
|---|---|
| K | 0.0000 |
| C1 | 1.33648480e−007 |
| C2 | 1.61152790e−012 |
| C3 | 5.10283905e−016 |
| C4 | −3.83443226e−020 |
| C5 | −1.66200289e−024 |
| C6 | 5.36831225e−030 |
| C7 | 0.00000000e+000 |
| C8 | 0.00000000e+000 |
| C9 | 0.00000000e+000 |

SURFACE NR. 42

| | |
|---|---|
| K | 0.0000 |
| C1 | −6.67594705e−008 |
| C2 | −1.57371543e−011 |
| C3 | −2.40090951e−015 |
| C4 | −1.23619193e−019 |
| C5 | 1.40244156e−022 |
| C6 | 2.04739553e−027 |
| C7 | 0.00000000e+000 |
| C8 | 0.00000000e+000 |
| C9 | 0.00000000e+000 |

1. A microlithography projection objective having an optical axis, comprising:
at least one lens of uniaxial birefringent crystal whose principal axis is oriented parallel to the optical axis,
wherein all lenses of uniaxial birefringent crystal comprise the same crystal material, light is tangentially polarised in the lens of uniaxial birefringent crystal, and the lens of uniaxial birefringent crystal has a diffractive power different from zero and has a plane exit face or a non-plane but refractive power-less exit face.

2. A microlithography projection objective having an optical axis, comprising:
at least two lenses of uniaxial birefringent crystal whose principal axes are oriented parallel to the optical axis,
wherein the at least two lenses are arranged rotated relative to each other about their principal axes.

3. The microlithography projection objective of claim 1 wherein the microlithography projection objective has an image field with a plurality of image elements with each of which a respective chief ray is associated, wherein each chief ray in all lenses of uniaxial birefringent crystal extends at an angle of less than 2° relative to the optical axis of the projection objective.

4. The microlithography projection objective of claim 1 wherein said crystal material is selected from the group which contains sapphire, akermanite, gehlenite, beryllium, apatite, terbium fluoride, beryllium oxide, cerium fluoride, neodymium fluoride, praseodymium fluoride, lanthanum fluoride, phenakite, AlPO₄, aluminum nitride, lithium nitrate, chloromagnesite, fluoroapatite, Al₈O₁₇Sr₅, taaffeite and dolomite.

5. The microlithography projection objective of claim 1 wherein the microlithography projection objective is telecentric at the image side.

6. The microlithography projection objective of claim 1 wherein the at least one lens counts among three optical elements which are closest to the image plane.

7. The microlithography projection objective of claim 1 wherein the microlithography projection objective is used at a wavelength of light and at said wavelength the material has a difference in the refractive indices for the ordinary and extraordinary rays, which exceeds 1·10⁻⁵.

8. The microlithography projection objective of claim 1 wherein the refractive index for the ordinary ray of the material of said lens numerically exceeds an image-side numerical aperture by more than 0.15 through 1.

9. The microlithography projection objective of claim 1 wherein at least one lens carries on its entrance face an isotropic layer whose refractive index is equal to a refractive index in the range from the ordinary to the extraordinary refractive index of the material of said lens.

10. The microlithography projection objective of claim 1 wherein the at least one lens is a planoconcave lens.

11. The microlithography projection objective of claim 1 wherein an immersion fluid is arranged between said lens and an adjacent lens.

12. The microlithography projection objective of claim 1 wherein said lens is preceded in the ray path by a second lens whose adjacent face is in concentric relationship with the adjacent face of said lens.

13. The microlithography projection objective of claim 1 wherein the optical axis of said lens is oriented in parallel relationship with the optical axis of the geometrical ray path in the projection objective.

14. The microlithography projection objective of claim 1 wherein said lens is arranged at the image side of a pupil closest to the image plane or a system aperture.

15. The microlithography projection objective of claim 1 wherein the image-side numerical aperture is greater than 1.4.

16. The microlithography projection objective of claim 1 wherein said lens is approximately hemispherical and the radius of the convex face differs from the lens thickness by below 20% of the lens thickness.

17. A microlithography projection exposure apparatus comprising:
the microlithography projection objective of claim 1;
a light source; and
an illumination system.

18. The microlithography projection exposure apparatus of claim 17 wherein during operation polarised light passes through said lenses.

19. The microlithography projection exposure apparatus of claim 18 wherein said light is tangentially polarised.

20. The microlithography projection exposure apparatus of claim 18 wherein said light is composed of linearly polarised beams.
